(19) United States
(12) Patent Application Publication
(10) Pub. No.: US 2013/0121502 A1
(43) Pub. Date: May 16, 2013

(54) VEHICULAR SOUND PROCESSING APPARATUS AND VEHICULAR APPARATUS

(71) Applicant: DENSO CORPORATION, Kariya-city (JP)

(72) Inventors: Masahiro FUJII, Obu-city (JP); Koichi Masuda, Obu-city (JP)

(73) Assignee: DENSO CORPORATION, Kariya-city (JP)

(21) Appl. No.: 13/662,698

(22) Filed: Oct. 29, 2012

(30) Foreign Application Priority Data
Nov. 10, 2011 (JP) 2011-246386

(51) Int. Cl. H04B 3/00

(52) U.S. Cl. 381/77

(57) ABSTRACT

A vehicular apparatus receives music data from a portable terminal through a first communication device and stores the music data to a memory unit. The vehicular apparatus then outputs the music data stored to a music playback apparatus. The vehicular apparatus continues the output of the music data stored in the memory unit even after disconnection of the first communication device with the portable terminal, and the vehicular apparatus output the music data when the vehicular apparatus receives the music data from the portable terminal through a second communication device, without interrupting the playback of the music data over the switching of communication devices.

### CROSS REFERENCE TO RELATED APPLICATION

The present application is based on and claims the benefit of priority of Japanese Patent Application No. 2011-246386, filed on Nov. 10, 2011, the disclosure of which is incorporated herein by reference.

### TECHNICAL FIELD

The present disclosure generally relates to a vehicular sound processing apparatus that is connectable to a portable terminal through multiple communication units and a vehicular apparatus that includes such vehicular sound processing apparatus.

### BACKGROUND

Conventionally, as disclosed in, for example, Japanese Patent No. 4,083,996 (JP '996) a display apparatus performs, in a cradle installed state for wired connection with an arithmetic processing apparatus (i.e., a host computer), wired communication with the arithmetic processing apparatus. The display apparatus in a user carried state, removed from the cradle, performs wireless communication with the arithmetic processing apparatus, with switching between the wired and wireless communication smoothed out by not involving the user in a process required for such switching, such as a registration process or a connection process.

The above-described situation may be found as a relationship between an in-vehicle device, such as a vehicular audio device, and a cellular phone. For example, the wired communication between the in-vehicle device and the cellular phone, transmits music/sound data from the cellular phone to the in-vehicle device for the playback of the music/sound data in the vehicle and switching to wireless Bluetooth (a registered trademark) communications after disconnection of the wired connection therebetween during the music playback, may be the case.

The above situation may be more practically described as handing a cellular phone, which is actively operated in a wired communication connected state by one occupant in a vehicle, from an occupant in a front seat of the vehicle to another occupant in a rear seat, resulting in switching from wired to wireless communication. In such a case, how to continue the playback of the music in the in-vehicle device may be an issue, which may be taken care of by devising some scheme for transfer of the music data from the cellular phone during switching from the wired to wireless communication.

According to JP '996 a technique for switching may be provided as,

(1) Information exchange and a registration/connection process required for the wireless connection are performed in advance between the cellular phone and the in-vehicle device during the playback of the music through the wired connection therebetween.

(2) Upon disconnecting the wired connection therebetween, switching to wireless communication is performed. During switching, the music playback performed by the wired connection is stopped.

(3) The in-vehicle device sends a music data transfer request to the cellular phone side via wireless communication.

(4) The playback of the music data transmitted by wireless communication from the cellular phone is performed (i.e., started) in the in-vehicle device.

In other words, by the sequence mentioned above, the playback of the music stops (i.e., is interrupted) between (2) to (4), which is not preferable. Further, similar situation may also be experienced during the switching between two communication protocols, besides the switching between the wired and wireless communication.

### SUMMARY

The present disclosure provides a vehicular sound processing apparatus including a first communication unit and a second communication unit. The first communication unit receives sound data from a portable terminal and stores the sound data to a memory unit. A control unit outputs the sound data stored from the memory unit to a sound playback apparatus.

The control unit continuously outputs the sound data from the memory unit even when communication by the first communication device with the portable terminal is disconnected, and the output of the sound data stored is switched to the output of the sound data received by the second communication unit when the second communication unit receives the sound data from the portable terminal. Therefore, even when communication with the portable terminal by one communication device is once interrupted and then resumed by a different communication device, the playback of the sound data is continued without interruption.

Further, a vehicular apparatus may include the above-described vehicular sound processing apparatus and a vehicular display unit for use in a vehicle. The vehicular display unit is coupled with the portable terminal, where the portable terminal has a display unit. In addition, the vehicular sound processing apparatus acquires pixel information regarding a screen image on a screen of the display unit of the portable terminal, and displays the screen image of the portable terminal on the vehicular display unit based on the pixel information. In other words, the vehicular apparatus is capable of performing a virtual network computing (VNC), which is in the present disclosure used as a generic term for indicating the virtual network computing.

Further, when a user operation is performed in association with the screen image of the portable terminal, which is being displayed on the vehicular display unit, a pixel area of the screen of the display unit of the portable terminal corresponding to a user operated pixel area of the vehicular display unit is identified as a target operation area. The vehicular sound processing apparatus sends a signal representing the target operation area to the portable terminal upon identifying the target operation area. An operation state of the vehicular apparatus is self-recognized regarding whether it is in a sound playback state or in a sound stop state based on at least one of the user operation performed in association with the screen image of the portable terminal displayed on the vehicular display unit and a reception state of the sound data.

Accordingly, if the vehicular apparatus is in a state to perform the VNC, the vehicular apparatus simply transfers the operation signal toward the portable terminal, under control of the portable terminal. That is, the vehicular apparatus may not be able to recognize its own operation state. Therefore, in the manner described above, the vehicular apparatus can securely recognize its own operation state, regarding whether the apparatus is playing the sound/music data or not based on the user operation.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of an in-vehicle music playback system of the present disclosure;

FIG. 2 is a flowchart of a process performed between an in-vehicle device and a cellular phone of the in-vehicle music playback system;

FIG. 3 is a sequence diagram of the process of FIG. 2

FIG. 4 is an illustration of a seamless playback function ON/OFF setting screen;

FIG. 5 is a time chart of sound volume change of music playback over a communication method switch timing in a second embodiment of the present disclosure;

FIG. 6 is a flowchart of a process performed by the in-vehicle device for storing music data transmitted from the cellular phone in a third embodiment of the present disclosure;

FIG. 7 is a flowchart of a process for handling a disconnection of communication between the in-vehicle device and the cellular phone in a fourth embodiment of the present disclosure;

FIGS. 8A and 8B are illustrations of a screen for a virtual network computing (VNC) and a screen for an audio playback operation input in a fifth embodiment of the present disclosure;

FIG. 9A is a flowchart of a process for VNC of the fifth embodiment of the present disclosure

FIG. 9B is a flowchart of a music playback process for the VNC process of FIG. 9A; and

FIG. 10 is an illustration of a screen in the in-vehicle device in a sixth embodiment of the present embodiment.

### DETAILED DESCRIPTION

### First Embodiment

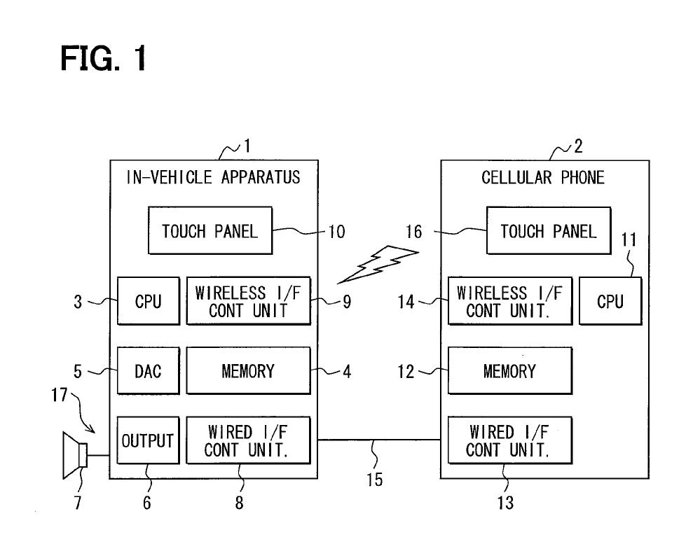

The first embodiment is illustrated with reference to FIGS. 1 to 4. FIG. 1 shows a block diagram of an in-vehicle music playback system in the first embodiment of the present disclosure. The in-vehicle music playback system includes an in-vehicle apparatus 1 (i.e., a vehicular sound process apparatus, a vehicular apparatus in claims) and a cellular phone 2 (i.e., a portable terminal in claims).

The in-vehicle apparatus 1 includes a CPU 3, a memory 4, a Digital Analog converter (DAC) 5, a sound output unit 6, a speaker 7 and the like. The memory 4 may include, for example, a ROM, a RAM, a flash memory, and stores, for example, music data (i.e., voice data and sound data) in a compressed coding format such as an MP3. The CPU 3 decodes the music data retrieved from the memory 4 and provides the decoded data to the DAC 5. The voice signal converted into an analog signal by the DAC 5 is filtered and amplified by the sound output unit 6, which is outputted from the speaker 7. The CPU 3, the DAC 5, the sound output unit 6, and the speaker 7 may be provided as a sound playback apparatus 17.

The in-vehicle apparatus 1 includes a wired interface (I/F) control unit 8 (i.e., a communication unit in claims) and a wireless interface (I/F) control unit 9 (i.e., a communication unit in claims). The wired interface control unit 8 is an interface for performing wired communications by using a communication protocol, such as USB. The wireless interface control unit 9 is an interface for performing wireless communications by using a communication protocol, such as Bluetooth (a registered trademark).

Further, the in-vehicle apparatus 1 includes a touch panel 10 (a setting unit). The touch panel 10 consists of a display having a touch panel function, displaying user input information and operation button images prompting the user input operation as well as displaying an execution condition of the function.

A input from a user, in response to the displayed contents (i.e., displayed screens), may be an input not only from the touch panel but also from a remote operation switch device, such as a joystick.

The cellular phone 2 includes a CPU 11 for performing a control of device operations, a memory 12 having a ROM, a wired interface (I/F) control unit 13 (i.e., a communication unit in claims) and a wireless interface (I/F) control unit 14 (i.e., a communication unit in claims). The wired and wireless interface control units 13, 14 respectively correspond to the wired and wireless interface control units 8, 9 of the in-vehicle apparatus 1. Specifically, the wired interface control unit 13 performs wired communications with the wired interface control unit 8 via a communication cable 15, and the wireless interface control unit 14 performs short range wireless communications with the wireless interface control unit 9 through an electric wave signal.

The memory 12 stores compressed music data compressed by a predetermined coding format together with other data. The CPU 11 transmits the music data that is retrieved from the memory 12 according to the user operation through the wired and wireless interface control units 13, 14 after modulating the data by using an appropriate protocol. Further, the cellular phone 2 includes a touch panel 16 (i.e., a display unit in claims), which is similar to the touch panel 10 of the in-vehicle apparatus 1, such as a touch panel on a smartphone.

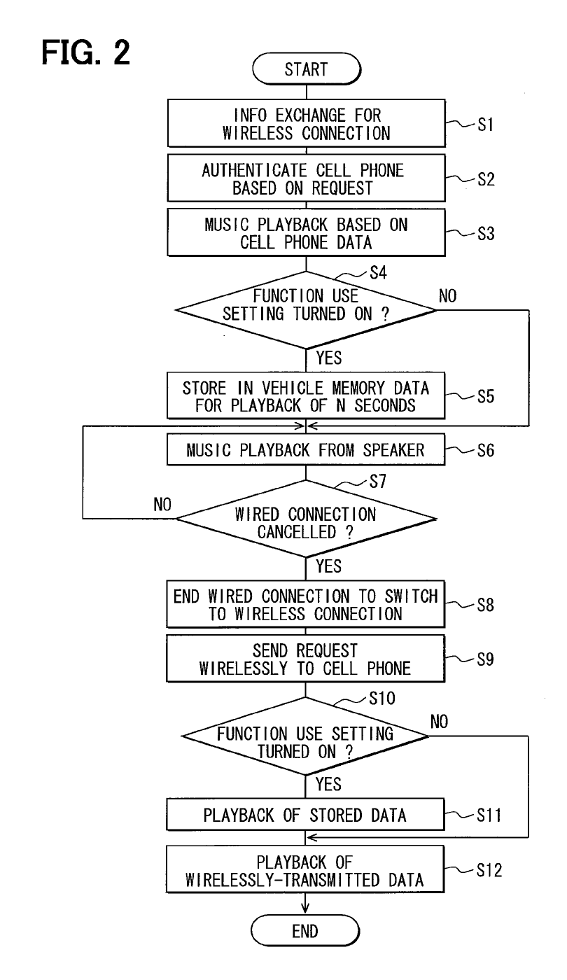

The operation and effect of the present embodiment are described with reference to FIGS. 2 to 4 in the following.

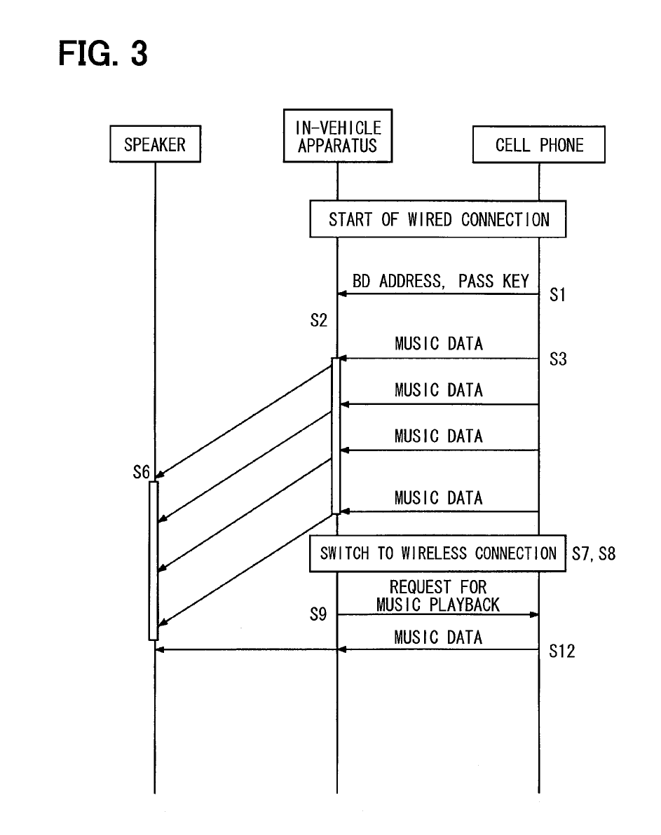

FIG. 2 is a flowchart of a process in which both of the in-vehicle apparatus 1 and the cellular phone 2 are involved, and FIG. 3 is a sequence chart of the same process, illustrating step-by-step procedures in those devices. The process in FIG. 2 starts with a point in time when the connection between the in-vehicle apparatus 1 and the cellular phone 2 is started through a wired connection. In S1, the cellular phone 2 exchanges information with the in-vehicle apparatus 1, that is, for example, authentication information, such as Bluetooth Device (BD) address or a pass key, which is required for performing wireless communication with the in-vehicle apparatus 1. In, S2, the in-vehicle apparatus 1 performs an authentication based on an authentication request from the cellular phone 2.

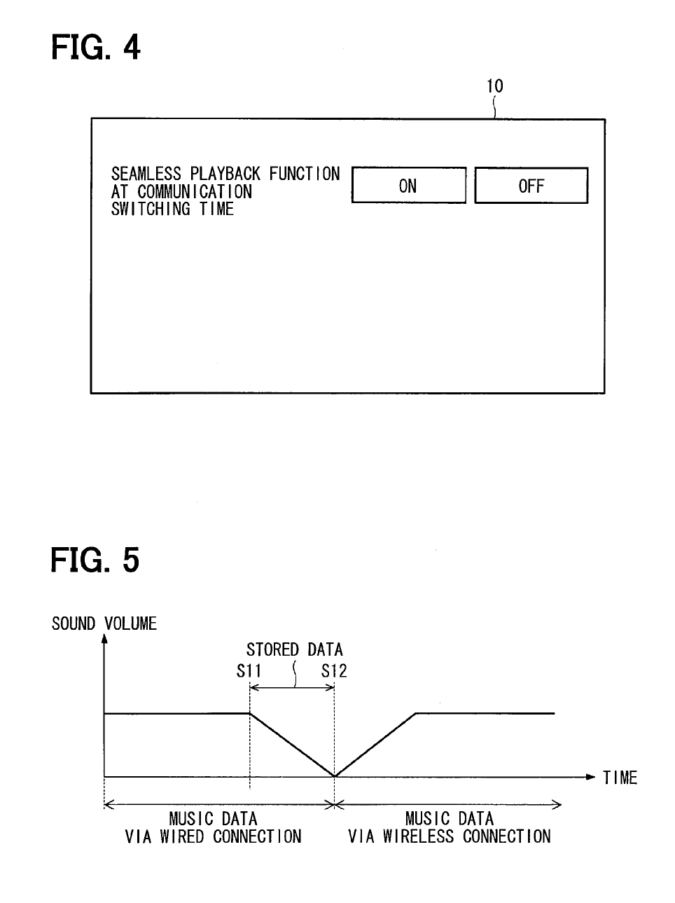

Based on a user's operation of the cellular phone 2, in S3, when the music data stored in the memory 12 of the cellular phone is transmitted to the in-vehicle apparatus 1, for a playback of the music, the in-vehicle apparatus determines, in S4, whether a use of a characteristic function is set to “ON” by the user. For example, in FIG. 4, a setting screen displayed on the touch panel 10, for turning ON/OFF a characteristic function is shown. A message, such as “Seamless playback function at communication switch time” and an “ON” button plus an “OFF” button, are provided to the user. Thus, allowing the user to set one of ON (i.e., use) or OFF (i.e., non-use) for setting the seamless playback by, for example, touching one of two buttons.

If a use setting of, for example, a seamless playback function, is “ON” (S4:YES), the in-vehicle apparatus 1, in S5, stores the music data transmitted from the cellular phone 2 to a buffer area of the memory 4, for the amount of N seconds (e.g., 2 to 3 seconds of playback). The in-vehicle apparatus 1, in S6, begins to read the music data from the top of the buffer area, and outputs a sound signal to the speaker 7 through the DAC 5 and the sound output unit 6, for the playback of the music. Therefore, the playback will be started in the in-vehicle apparatus 1 after N seconds from the start of the transmission of the data by the cellular phone 2.

On the other hand, the process performs S6 without performing step S5 if the use setting of the seamless playback function is determined as “OFF” (S4:NO). Further, even after the start of the music playback in S6, the process for storing, to the buffer area of the memory 4, the music data that is transmitted from the cellular phone 2, is performed in parallel with the music playback.

The in-vehicle apparatus 1, in S7, monitors whether the wired communication with the cellular phone 2 is cancelled (i.e., is disconnected). Upon determining that the communication is cancelled (S7: YES), the in-vehicle apparatus 1, in S8, finishes the wired communication and shifts to wireless communication with the cellular phone 2 via the wireless interface control unit 9 and the wireless interface control unit 14.

The in-vehicle apparatus 1, in S9, requests for the transmission of the music data from the cellular phone 2 via the wireless communication. Similar to S4, the in-vehicle apparatus 1, in S10, determines if the use setting of the function concerned is “ON” (S10:YES), the retrieval of the music data accumulated from the memory 4 and the music playback are continued (S11). The in-vehicle apparatus 1, in S12, continues the music playback while accumulating, in the memory 4, the data sequentially transmitted by the cellular phone 2 through the wireless communications. Further, if the use setting of the above function is “OFF” (S10:NO), the in-vehicle apparatus 1 performs the music play back (S12) without the sequential storing of the music data of S11.

Further, if the retrieval/playback of the music data stored in the buffer area of the memory 4 is already finished, the music data wirelessly transmitted by the cellular phone 2 to the in-vehicle apparatus 1 may be directly transferred to the DAC 5 without firstly being stored in the memory 4, for the continuous playback of the music.

According to the present embodiment, the in-vehicle apparatus 1 stores, in the memory 4, the music data, which is received from the cellular phone 2 via the wired interface control unit 8 and the wired interface control unit 13. The must data stored in the memory 4 is outputted to the sound playback apparatus 17. When the connection to the cellular phone 2 through the wired communications is disconnected, the in-vehicle apparatus 1 continues the output of the music data stored in the memory 4. Specifically, the in-vehicle apparatus 1 receives the music data transmitted from the cellular phone 2 via the wireless communication between the wireless interface control unit 8 and the wireless interface control unit 14. Therefore, even when the communication with the cellular phone 2 by one communication interface (i.e., one communication unit) is once interrupted and then resumed by a different communication interface (i.e., resumed as a communication through a different communication unit) during an output and playback of the music data to the sound playback apparatus 17 which is transmitted by such communication with the cellular phone 2, the playback of the music data is continued without interruption.

In such case, the in-vehicle apparatus 1 outputs the music data to the sound playback apparatus 17 from the memory 4, after once storing the music data to the memory 4, which is received through the wired communication from the cellular phone 2, for the amount of predetermined time of playback. Therefore, even when a certain time is required from the disconnection of the wired communication to the start of the wireless communication, the playback of the music is continued without interruption by outputting (i.e., by continuing the output of) the music data that is stored in the memory 4 to the sound playback apparatus 17. That is, the otherwise-interrupted music playback is now continued by using the memory-stored music data.

Further, the in-vehicle apparatus 1 requests the transmission of the music data from the cellular phone 2 after the disconnection of the wired communication with the cellular phone 2 and the start of the wireless communication. Therefore, the transmission of the music data from the cellular phone 2 is prompted even when the cellular phone 2 does not transmit the music data automatically at the time of start of the wireless communication. Furthermore, when the wired communication is established between the in-vehicle apparatus 1 and the cellular phone 2, the authentication procedure to enable wireless communication between the wireless interface control unit 8 and the wireless interface control unit 14 is performed. Therefore, by performing the authentication procedure in advance, the switch from the wired communication to the wireless communication takes only a short time.

Further, the user is allowed to set whether or not to execute the function that continues the output of the music data stored in the memory 4 at the time of the disconnection of the wired communication with the cellular phone 2, which is enabled by the pre-storage of the music data in the memory 4 after transmission of the music data from the cellular phone 2. In other words, if the above function is executed, the execution of such function causes a wait time before the start of the music playback, which may not be desired depending on the user's preference, or depending on the actual state in the vehicle. That is, the user desire of not-using an auto-continue function for continuing the music playback is accommodated in this manner.

### Second Embodiment

FIG. 5 illustrates the second embodiment, in which the difference from the first embodiment mainly described with like numbers representing like parts. The diagram in FIG. 5 is a time chart of the sound volume of the music playback in the in-vehicle apparatus 1. The vertical axis of the chart represents the sound volume, and the horizontal axis of the chart represents time. In the second embodiment, while the in-vehicle apparatus 1 plays the music data stored in the memory 4, due to the interruption of the music data transmission by the disconnection of the wired communication with the cellular phone 2, the sound volume of the music playback is gradually decreased (i.e., fade-out). Once the in-vehicle apparatus 1 is connected to the cellular phone 2 by the wireless communication and the transmission of the music data is restarted, the sound volume is gradually increased (i.e., fade-in).

According to the second embodiment, the in-vehicle apparatus 1 outputs the sound signal based on the music data stored in the memory 4 in a manner that gradually decreases the sound volume when the connection of the wired communication with the cellular phone 2 is disconnected, and, when the in-vehicle apparatus 1 receives the music data from the cellular phone 2 by the wireless communication, the in-vehicle apparatus 1 outputs the sound signal based on the music data received in a manner that gradually increases the sound volume.

In such manner, the user can recognize, in a music data playback continuation state, that the means for communication between the in-vehicle apparatus 1 and the cellular phone 2 is switched. Further, even if the transition from the wired communication to the wireless communication takes a long time, such that the music data stored in the memory 4 is exhausted and causes an interruption of the music data playback, the transition from the interruption of the playback to the resume of the playback is natural.

### Third Embodiment

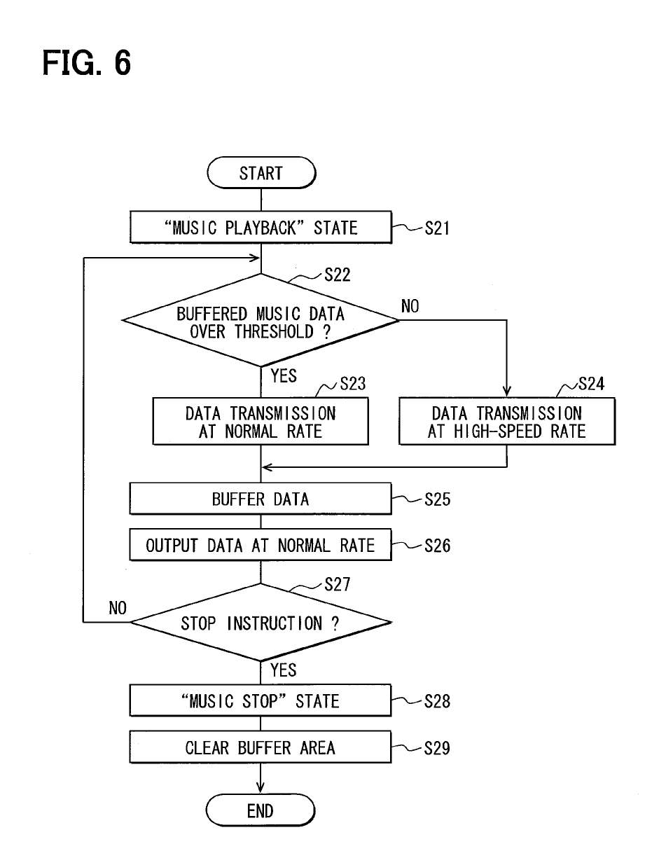

FIG. 6 illustrates the third embodiment, in which the difference from the first embodiment is that, the first embodiment in step S5 or in step S12, which is a buffering process for storing the music data from the cellular phone 2 into the memory 4, is described in more detail. This process is started when the user performs an input operation on the in-vehicle apparatus 1, or when the music data is received by the in-vehicle apparatus 1.

At first, a state variable, or a flag, which represents a state of the in-vehicle apparatus 1 (i.e., the music playback apparatus 17), is set to “During playback” (S21), the amount of music data in a buffer area of the memory 4 at such moment is measured, and whether the amount of music data measured is equal to or greater than a threshold is determined in S22. The method for measuring the amount of music data in the buffer area may be a well-known method, such as the one disclosed in, for example, paragraph [0022] of the Japanese patent publication No. JP-A-H07-170504.

If the amount of music data stored in the buffer area is equal to or greater than a predetermined value (S22:YES), the in-vehicle apparatus 1, in S23, instructs the cellular phone 2 to transmit the music data at a normal data transmission rate. On the other hand, if the amount of music data is less than the predetermined value (S22:NO), the in-vehicle apparatus 1, in S24, instructs the cellular phone 2 to transmit the music data at a high-speed data transmission rate. The in-vehicle apparatus 1, in S25, writes the music data which is transmitted either at the normal rate or at the high-speed rate to the buffer area of the memory 4 (i.e., buffering), and, in S26, outputs the music data to the music playback apparatus 17 at the normal transmission rate.

In S27, the in-vehicle apparatus 1 determines whether the user has performed a stop instruction for stopping the music playback. If such instruction is not provided (S27:NO), the in-vehicle apparatus 1 returns to S22. If such instruction is provided (S27:YES), the in-vehicle apparatus 1, in S28, sets the state variable to “During stop”. The in-vehicle apparatus 1, in S29, then clears the buffer area of the memory 4 (S29), and finishes the process.

The state variable may be cleared (i.e., set to “During stop”), for example, when a key switch in the vehicle is turned to ACC (i.e., accessory)=OFF, and the process may be started in a state variable cleared condition when the key switch is subsequently turned to IG (i.e., ignition)=ON. In such manner, an unintentional start of the music playback at the subsequent turning ON of the IG is prevented.

Further, without clearing the state variable at the time of ACC=OFF, the “During playback” state at such moment may be memorized. In such manner, the subsequent IG=ON leads to the auto start of the playback, on a condition that the state variable is “During playback.”

Further, the buffer area of the memory 4 may be cleared when ACC=OFF.

According to the third embodiment, the in-vehicle apparatus 1 requests the cellular phone 2 to transmit the music data at the high-speed rate, which is higher than a predetermined transmission rate (i.e., a normal transmission rate), and stores the music data at the high-speed transmission, until the amount of music data in the memory 4 exceeds the predetermined amount. Upon detecting that the amount of music data stored is equal to or greater than the predetermined amount, the in-vehicle apparatus 1 requests the cellular phone 2 to transmit the music data at the predetermined transmission rate, and stores the music data at the predetermined transmission rate. In such manner, the in-vehicle apparatus 1 can quickly store (i.e., can quickly buffer) the music data more than the predetermined amount in the memory 4.

Further, the continuous music playback is enabled by utilizing the music data buffered, which is received after the previous switching of the communication unit by storing the data by the predetermined amount, even when the switching of the communication unit is performed/repeated twice or more.

### Fourth Embodiment

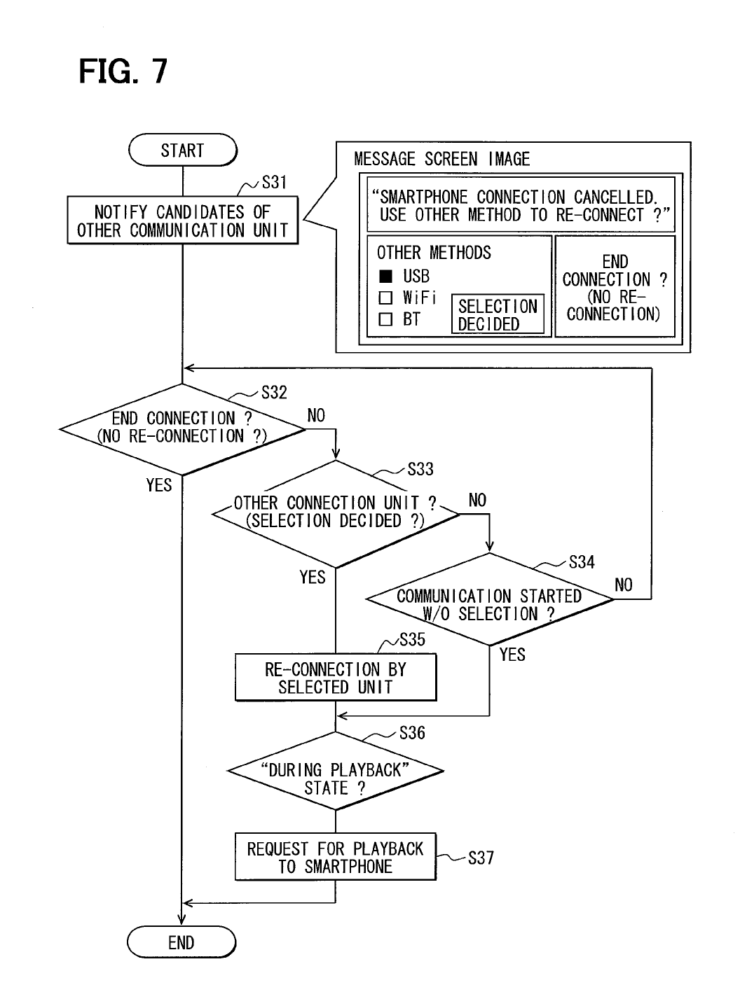

FIG. 7 illustrates the fourth embodiment, in which the difference from the first embodiment is that the communication unit after a disconnection may be selected by the user. Though the disconnection of the wired communication with the cellular phone 2 automatically leads to the connection of the wireless communication in the first embodiment, the disconnection of the wired communication in the fourth embodiment may lead to user-selected communication, such as a communication unit using Bluetooth (BT), a Wi-Fi (a registered trademark) communication unit, or the like. Further, in the fourth embodiment, an assumption that the in-vehicle apparatus 1 is connected to the cellular phone 2 via the wired communication may not have to be assumed (i.e., is not necessary).

As shown in FIG. 7, communication with the cellular phone 2 is in a disconnected state, and the in-vehicle apparatus 1, in S31, notifies a user that communication units are available as candidate units by displaying a message on the touch panel 10. For example, the displayed message may read “Connection to the smart phone is interrupted. Would you like to reconnect by other communication methods ?” accompanied by the communication units, such as USB, Wi-Fi, BT, and allowing the user to select one of those candidates. Further, when the user does not want to reconnect by other communication methods, the user may be allowed to select an “End” option, ending the communication.

When the user selects the “End” option on the screen (S32:YES), the process performed by the in-vehicle apparatus 1 concludes itself without re-connecting the communication between the in-vehicle apparatus 1 and the cellular phone 2. When the user selects one of USB, Wi-Fi, or BT (i.e., one of the communication unit candidates) on the screen and then touches “Selection Decided” (i.e., OK) (S33:YES), the in-vehicle apparatus 1, in S35, performs a reconnection per the communication unit selected. In such case, the state variable is set to “During playback”, in S36, and the in-vehicle apparatus 1, in S37, requests the transmission of the music data from the cellular phone 2.

Further, when, in S33, communication is auto-started (S34:YES) without the user selection selecting one communication unit (S33:NO), that is, without an explicit user selection of the communication unit, communication is performed and the process proceeds to S36. In the fourth embodiment, the state variable in case of ACC=OFF may be controlled in the same manner as the third embodiment.

According to the fourth embodiment described above, the in-vehicle apparatus 1 displays available candidates of a desired communication unit, and allows the user to select one, when communication with the cellular phone 2 is disconnected. Therefore, the user is enabled to switch to the desired communication unit.

### Fifth Embodiment

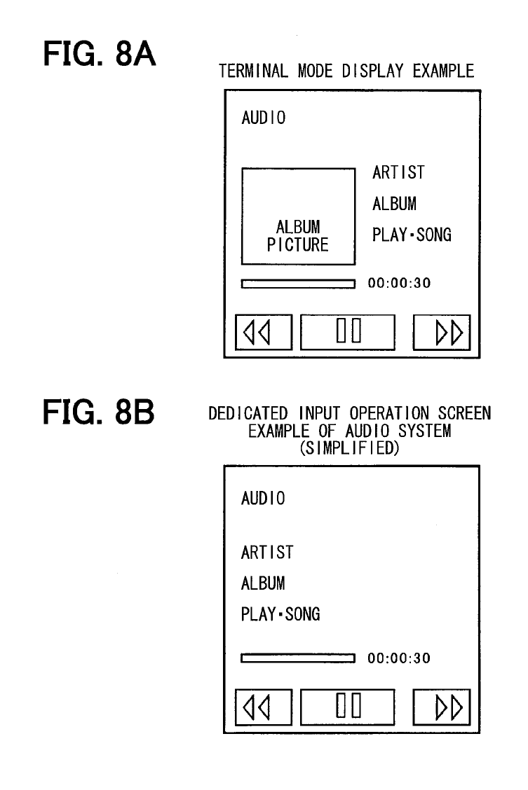

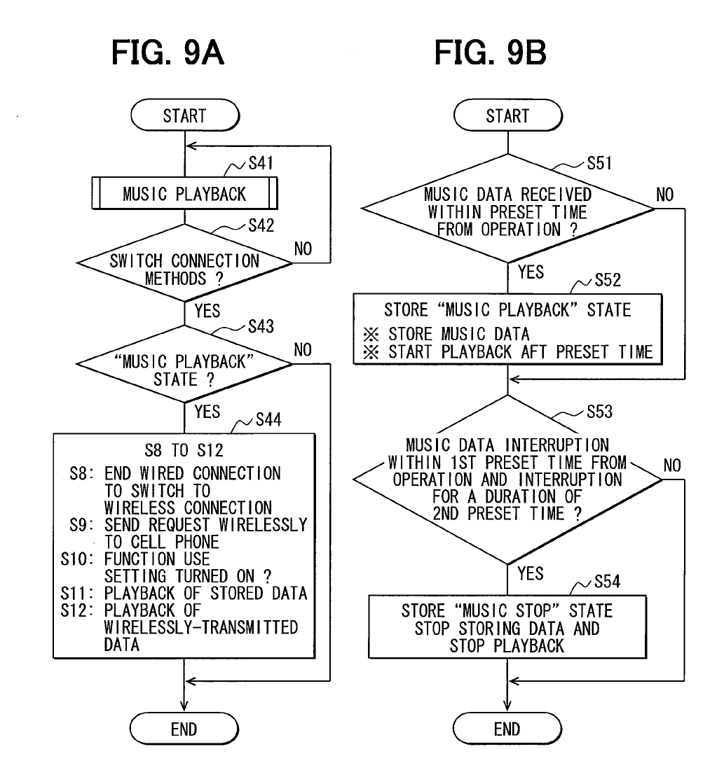

FIGS. 8A-9B illustrates the fifth embodiment, in which the in-vehicle apparatus 1 and the cellular phone 2 cooperatively perform a virtual network computing function (VNC: a registered trademark). The VNC allows the user to perform an operation on the in-vehicle apparatus 1 to control the cellular phone 2, which is enabled by transmitting and displaying the screen of the touch panel 16 of the cellular phone 2 on the touch panel 10 of the in-vehicle apparatus 1, and by receiving the user input on the touch panel 10 of the in-vehicle apparatus 1.

More practically, when the in-vehicle apparatus 1 acquires pixel information of a touch panel screen displayed on the touch panel 16 of the cellular phone 2 via the communication connection (i.e., wired or wireless communication), the in-vehicle apparatus 1 displays a screen on the touch panel 10 based on the pixel information acquired. Upon receiving a touch operation of the touch panel 10 by the user, the touch operation is interpreted and identified as a corresponding pixel area of the touch panel screen of the touch panel 16, and signal indicating such pixel area is transmitted to the cellular phone 2.

FIG. 8A is an illustration of an example of a screen display of the touch panel 10 in the VNC, and FIG. 8B is an illustration of an example of an input operation screen, which is an initial screen of the in-vehicle apparatus 1 dedicated for the audio system.

FIGS. 9A and 9B are flowcharts of processes performed by the in-vehicle apparatus 1 when performing the VNC. FIG. 9A provides a process after the start of a terminal mode, in which a loop of S41 and S42 is performed when the in-vehicle apparatus 1 and the cellular phone 2 are initially connected by t wired communication, where S41, regarding a music playback process, is detailed in FIG. 9B.

In FIG. 9B, upon receiving the music data from the cellular phone 2 within a preset time from the user operation on the touch panel screen of FIG. 8A on the touch panel 10 (S51:YES) the in-vehicle apparatus 1, in S52, stores its operation state as “Music playback”. The in-vehicle apparatus 1 stores and playbacks the music data received from the cellular phone 2, in the same manner as S5, S6 of the first embodiment.

During the execution of VNC, the in-vehicle apparatus 1 transfers the user operation on the touch panel 10 to the cellular phone 2 as an operation signal, and accepts the resulting operation of the cellular phone 2. Therefore, the in-vehicle apparatus 1 does not positively recognize its own control state other than the VNC setting. Thus, the in-vehicle apparatus 1 recognizes its own control state as “Music playback” based on the determination “YES” in S51, and stores such recognition as a flag.

In S53, the in-vehicle apparatus 1 determines whether the music data transmitted from the cellular phone 2 is being interrupted. Specifically, such interruption starts within a first preset time from the user operation of the touch panel screen of the touch panel 10, and the duration of such interruption is continued for at least a second preset time, where the first preset time being different from the second preset time, and both the first and second preset time of S53 being different from the preset time of S51.

When it is determined as the interruption of the transmission of the music data (S53:YES), the in-vehicle apparatus 1 recognizes a state of “Music stop” and stores such state, such as a flag. The in-vehicle apparatus 1 then, in S54, stops a process to store the music data in the memory 4, and stops the playback of the music data. The process proceeds to S42. When it is determined as non-interruption of the transmission of the music data (S53:NO), the process proceeds to S42 without performing S54.

In S42 of FIG. 9A, it is determined whether the wired communication are switched to the wireless communication (i.e., a connection method has been changed) just like the first embodiment. If it is determined that the switching to the wireless communication has not been performed (S42:NO), the process returns to S41.

On the other hand, if it is determined the switching to the wireless communication has already been performed (S42:YES), the in-vehicle apparatus 1, in S43, determines whether it is in a state of “Music playback”. and, if it is in the “Music playback” state (S43:YES), the same process as steps S8 to S12 of the first embodiment is performed, where S10 may be skipped in S44, and the VNC process is concluded. At such moment, the screen of the touch panel 10 switches to the one in FIG. 8B. If the apparatus 1 is not in the “Music playback” state (S43:NO), the VNC process is also concluded.

According to the fifth embodiment, the in-vehicle apparatus 1 is configured to perform the VNC, and recognizes its “Music playback” state when receiving the music data from the cellular phone 2 within a preset time from the touch operation by the user on the touch panel unit 10. The in-vehicle apparatus 1 recognizes its “Music stop” state when the interruption of the music data continues for more than the first preset time. Therefore, the in-vehicle apparatus 1 can securely determine whether it is playing the music data even when the in-vehicle apparatus 1 operates in VNC.

Further, when communication by a first communication unit (i.e., the wired communication) with the cellular phone 2 is disconnected and the in-vehicle apparatus 1 is in the “Music playback” state, the in-vehicle apparatus 1 requests the transmission of the music data for the cellular phone 2. In such manner, the timing for requesting the transmission of the music data is securely determined, thereby avoiding an unnecessary request for the transmission of the music data to be transmitted to the cellular phone 2.

Further, when the in-vehicle apparatus 1 receives the music data from the cellular phone 2, the in-vehicle apparatus 1 finishes a display of a screen corresponding to the screen of the cellular phone 2, and displays, on the touch panel 10, a dedicated input operation screen, allowing the user to start/stop the music playback of its own. That is, instead of displaying the VNC screen, the in-vehicle apparatus 1 displays its original screen dedicated for, for example, the audio system. Therefore, the user is enabled to easily perform the input operation with reference to the touch panel 10 on the in-vehicle apparatus 1 side. Further, the operation on the dedicated screen regarding the start/stop of the playback of the music data can be recognized by the in-vehicle apparatus 1 itself, the operation state of the in-vehicle apparatus 1 is recognized by itself, based on the operation information about the operation of the buttons on the dedicated screen. That is, whether the in-vehicle apparatus 1 is in a state of music playback, or in a music playback stop state can be determined and distinguished, after displaying the dedicated input operation screen.

Further, the in-vehicle apparatus 1 may display the dedicated input operation screen of its own on top of the VNC screen when it has received the music data from the cellular phone 2.

### Sixth Embodiment

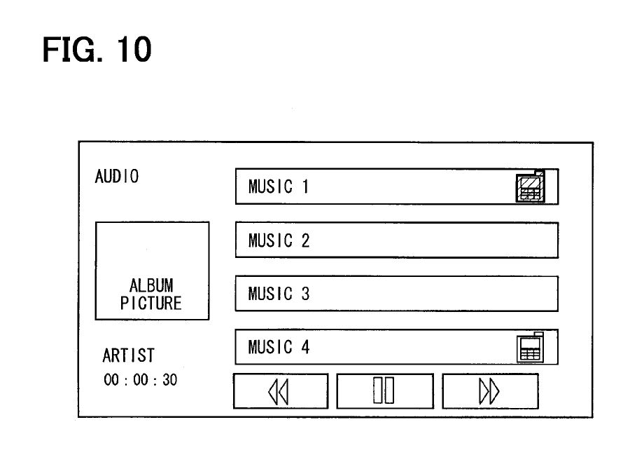

FIG. 10 illustrates the sixth embodiment, in which the in-vehicle apparatus 1 displays on the screen of the touch panel 10 which one of the music data is the one transmitted from the cellular phone 2, by using an icon. In other words, the user can recognize the music data currently being transmitted from the cellular phone 2 and currently being played back, which are Music 1 and Music 4 in FIG. 10, having an icon displayed therewith. FIG. 10 shows that the playback of Music 1 has already been finished (shaded icon) and Music 4 is currently being transmitted from the cellular phone 2 (non-shaded icon) and currently being played. Music 2 and Music 3 are the music data stored on the in-vehicle apparatus 1.

Further, an example of FIG. 10 may be applied to the dedicated input operation screen of FIG. 8B, showing an icon on the screen in the same manner as FIG. 10. In such manner, the user can easily recognize whether the currently played music data is the one stored in the in-vehicle apparatus 1 or the one being transmitted from the cellular phone 2.

Based on the disclosed embodiments, a vehicular sound processing apparatus performs the output of stored sound data from the memory unit 4 after storing, to the memory unit, the sound data received by a first communication device (e.g. wired communication) for an amount of a predetermined time of playback. Therefore, even when it takes time to resume communication with a portable terminal (e.g., cellular phone 2) by a second communication device (e.g., wireless communication) after disconnection of communication by the first communication unit, the output, or the playback, of the sound/music data is continued, or kept uninterrupted, by outputting the sound data stored in the memory unit after such disconnection of the communication.

Further, the vehicular sound processing apparatus may perform wired communication by using the first communication unit, and may perform wireless communication by using the second communication unit. Therefore, even when the wired communication is switched to the wireless communication, the playback of the sound/music data is continued without interruption.

Further, when communication with the portable terminal is started by the second communication device after the first communication device disconnects communication with the portable terminal, a request for transmission of the sound data is sent to the portable terminal. Therefore, even when the portable terminal does not spontaneously transmit the sound/music data at a time of starting of communication by the second communication device, the transmission of the sound/music data is prompted.

Further, when communication by the first communication device is connected, an authentication procedure is performed in advance for enabling the communication by the second communication device. Therefore, even when the authentication procedure takes time to complete, the authentication procedure performed and completed in advance enables a smooth switching of communication from the first communication unit to the second communication unit (i.e., switching of communication is enabled in no time).

Further, when communication with the portable terminal by the first communication device is disconnected, an output volume of sound signal based on the sound data stored in the memory unit is gradually decreased. Subsequently, when the sound data is received from the portable terminal by the second communication unit, the output volume of the sound signal based on the received sound data is gradually increased. In such manner, switching between the two communication devices for the communication between the portable terminal and the vehicular sound processing apparatus during the continued playback of the sound/music data may be recognized by the user. Further, even when the playback of the sound data is interrupted in the course of switching of the communication devices, the transition from the interruption of the playback to the resume of the playback is made natural as much as possible.

Further, when a function for controlling (i) storage of the sound data to the memory unit upon receiving the sound data from the portable terminal by the first communication unit, and (ii) continuation of output of the sound data stored in the memory unit at a time of disconnection of communication with the portable terminal by the first communication device is provided as a sound data output continuation function, the vehicular sound processing apparatus may include a setting unit. The setting unit allows a user to set whether or not to perform a sound data output continuation function according to user preference, for switching ON and OFF of such function.

More practically, the setting unit allows a selection by the user either to use or not to use such function, according to the user preference or the actual condition of the vehicle compartment. That is, the apparatus is capable of responding to the user needs regarding the use of such function.

Further, when a high-speed transmission that is faster than a normal-speed transmission is available, a request for transmission of the sound data by a high-speed transmission is sent to the portable terminal and the sound data received is stored at the high-speed transmission to the memory unit until an amount of the stored sound data reaches a predetermined threshold. After having received the predetermined threshold amount of the sound data, a request for transmission of the sound data by the normal-speed transmission is sent to the portable terminal and the received sound data is stored at the normal-speed transmission to the memory unit. In such manner, the memory unit can quickly store (i.e., can quickly buffer) the sound/music data more than the predetermined threshold amount.

Further, an operation state of the vehicular sound processing apparatus is self-recognized as a sound playback state when a playback instruction of the sound data is received by the apparatus or when the sound data is received. The operation state of the vehicular sound processing apparatus is self-recognized as a sound stop state when a playback stop instruction of the sound data is received by the apparatus or when the sound data is interrupted for more than a predetermined period. That is, depending on the configuration of the vehicular sound processing apparatus, the apparatus may be able to recognized the operation state of the apparatus itself, in terms of whether or not the apparatus is playing the transmitted sound data or whether the apparatus is stopping the playback of the data. In such a case, the above-described apparatus can securely determine if the apparatus is currently playing the sound data.

Further, when communication by the second communication device is started after the disconnection of communication with the portable terminal by the first communication unit with the self-recognition of the operation state as the sound playback state, a request for transmission of the sound data is sent to the portable terminal. In such manner, the request timing for requesting the transmission of the sound/music data is securely determined, thereby avoiding an unnecessary request for the transmission of the sound/music data to be transmitted to the portable terminal.

Further, the vehicular apparatus self-recognizes its operation state as the sound playback state upon receiving the sound data, and the vehicular apparatus self-recognizes its operation state as the sound stop state upon detecting an interruption of the sound data for more than the predetermined time. Such configuration may also enable the vehicular apparatus to self-recognize its own operation state as the sound playback state or the sound stop state.

Further the vehicular apparatus self-recognizes the sound playback state upon receiving the sound data when the receiving of the sound data is within a preset period from the user operation in association with the screen image that is displayed on the vehicular display unit, and self-recognizes the sound stop state upon detecting an interruption of the sound data when the interruption of the sound data is within a preset period from the user operation in association with the screen image that is displayed on the vehicular display unit. Such configuration may also enable the vehicular apparatus to self-recognize its own operation state as the sound playback state or the sound stop state.

Further, when the vehicular apparatus receives the sound data from the portable terminal, the vehicular apparatus displays, on the vehicular display unit, a dedicated input operation screen for receiving an input operation that controls a playback or a stop of playback of the music data stored therein, in a manner of one of (i) replacing the display of the screen image of the screen of the portable terminal (i.e., the VNC screen image of the portable terminal) and (ii) superposing on the display of the screen image of the screen of the portable terminal. That is, when the VNC is finished and the dedicated input operation screen of the vehicular apparatus is displayed, the user can easily perform the user operation by viewing the vehicular display unit.

Although the present disclosure has been fully described in connection with preferred embodiment thereof with reference to the accompanying drawings, it is to be noted that various changes and modifications will become apparent to those skilled in the art.

For instance, in the first embodiment, it may be modified that a first communication unit is the wireless communication and a second communication unit is the wired communication.

A unit for turning ON/OFF of the use of a certain function in S4, S10 may be provided if it is necessary.

Further, the setting unit may not only be the touch panel but may also be a dedicated setting key or the like. Therefore, it is not necessary to have an independent display device as the display unit.

The authentication information for authenticating the connection of the communication may be provided according to the protocol of the selected communication type.

The selection of the other communication unit according to the user's preference in the fourth embodiment may be modified to the switching of the communication types according to a preset order, such as a switching sequence BT to Wi-Fi to USB to BT, etc.

The determination in S51 of FIG. 9B in the fifth embodiment, determining “Music playback” based on the touch operation on the touch panel 10, may be modified to the determination of “Music playback” based only on the reception of the music data transmitted from the cellular phone 2. Further, the determination in S53 of FIG. 9B may be modified in the same manner, determining “Music stop” based only on the interruption of the transmission of the music data from the cellular phone 2.

Further, the above determination criteria “Reception of the music data” and “Interruption of transmission of the music data” may be replaced with “Reception of music data playback instruction” and “Reception of music data playback stop instruction” from the cellular phone 2.

Further, the fifth embodiment may be applied to the in-vehicle apparatus 1 which is not operating in the VNC mode. Further, the in-vehicle device needs not have a touch panel.

The in-vehicle device may be implemented as a vehicular navigation apparatus. In other words, a function of the in-vehicle apparatus 1 or a configuration of realizing the function of the in-vehicle apparatus 1 may be added to a navigation apparatus.

The portable terminal needs not have a touch panel. That is, the portable terminal needs to have only an operation unit such as an operation key or the like which serves as a touch panel for accepting the touch operation and a display unit. Further, the portable terminal needs not be a cellular phone, but may be a music player dedicated for the playback of the music data.

The type of communications may be other kinds, such as a wireless LAN or the like.

Such changes, modifications, and summarized schemes are to be understood as being within the scope of the present disclosure as defined by appended claims.

What is claimed is:

1. A vehicular sound processing apparatus for connecting communication to a portable terminal by a plurality of communication devices, the apparatus comprising:
a first communication device receiving sound data from the portable terminal;
a second communication device receiving sound data from the portable terminal;
a memory unit storing the sound data; and
a control unit outputting the sound stored in the memory unit to a sound playback apparatus, wherein
the control unit continuously outputs the sound data from the memory unit when communication by the first communication device with the portable terminal is disconnected, and the output of the sound data stored is switched to the output of the sound data received by the second communication unit when the second communication unit receives the sound data from the portable terminal.

2. The vehicular sound processing apparatus of claim 1, wherein,
the control unit outputs the sound data from the memory unit after storing the sound data received by the first communication device for an amount of a predetermined time of playback.

3. The vehicular sound processing apparatus of claim 1, wherein
the first communication device performs communication through a wire medium, and
the second communication device performs communication through a wireless medium.

4. The vehicular sound processing apparatus of claim 1, wherein,
the control unit transmits a request for transmission of the sound data to the portable terminal when communication with the portable terminal is started by the second communication device after communication disconnection of the first communication device.

5. The vehicular sound processing apparatus of claim 1, wherein,
the control unit performs an authentication procedure in advance for enabling communication via the second communication device when communication with the portable terminal is connected via the first communication device.

6. The vehicular sound processing apparatus of claim 1, wherein,
the control unit gradually decreases an output volume of sound signal based on the sound data stored in the memory unit, when communication with the portable terminal by the first communication device is disconnected, and
the control unit gradually increases the output volume of the sound signal, when the sound data is received via a communication connection between the portable terminal and the second communication device.

7. The vehicular sound processing apparatus of claim 1 further comprising:
a setting unit setting whether or not to perform a sound data output continuation function according to a user preference, wherein
the function controls (i) storage of the sound data to the memory unit upon receiving the sound data from the portable terminal by the first communication unit and (ii) continuation of output of the sound data stored in the memory unit at a time of disconnection of communication with the portable terminal by the first communication device.

8. The vehicular sound processing apparatus of claim 1, wherein
the control unit transmits a request for transmission of the sound data by a high-speed transmission to the portable terminal and the sound data received is stored at the high-speed transmission to the memory unit until an amount of the sound data stored reaches a predetermined threshold, in which the high-speed transmission is faster than a normal-speed transmission, and
the control unit transmits a request for transmission of the sound data by the normal-speed transmission to the portable terminal and the received sound data is stored at the normal-speed transmission to the memory unit, when the amount of the sound data reaches the predetermined threshold.

9. The vehicular sound processing apparatus of claim 8, wherein
the control unit self-recognizes an operation state as a sound playback state when a playback instruction of the sound data is received or when the sound data is received, and
the control unit self-recognizes the operation state as a sound stop state when a playback stop instruction of the sound data is received or when the sound data is interrupted for more than a predetermined period.

10. The vehicular sound processing apparatus of claim 9, wherein
the control unit transmits a request for transmission of the sound data to the portable terminal when the second communication device begins communication with the portable terminal after the first communication unit disconnects communication with the portable terminal with the operation state as the sound playback state.

11. A vehicular apparatus comprising:
a vehicular display unit disposed in a vehicle, the vehicular display unit being coupled with a portable terminal having a display unit;
a vehicular sound processing apparatus including
a first communication device and a second communication device receiving sound data from the portable terminal; and
a memory unit storing the sound data; and
a control unit outputting the sound data stored in the memory unit to a sound playback apparatus, wherein the control unit continuously outputs the sound data from the memory unit when communication by the first communication device with the portable terminal is disconnected, and the output of the sound data stored is switched to the output of the sound data received by the second communication unit when the second communication unit receives the sound data from the portable terminal, wherein
the vehicular sound processing apparatus displays a screen image of the display unit of the portable terminal on the vehicular display unit based on the pixel information acquired from the portable terminal,
the vehicular sound processing apparatus sends a signal representing a target operation area to the portable terminal upon identifying the target operation area, the target operation area being a pixel area of the display unit of the portable terminal corresponding to a user operated pixel area of the vehicular display unit based on a user operation performed in association with the screen image of the portable terminable displayed on the vehicular display unit, and
the vehicular sound processing apparatus self-recognizes an operation state as a sound playback state or a sound stop state based on at least one of the user operation performed in association with the screen image of the portable terminal displayed on the vehicular display unit and a reception state of the sound data.

12. The vehicular apparatus of claim 11, wherein
the vehicular sound processing apparatus self-recognizes the sound playback state upon receiving the sound data, and
the vehicular sound processing apparatus self-recognizes the sound stop state upon detecting an interruption of the sound data for more than the predetermined time.

13. The vehicular apparatus of claim 11, wherein
the vehicular sound processing apparatus self-recognizes the sound playback state upon receiving the sound data when the receiving of the sound data is within a preset period from the user operation in association with the screen image that is displayed on the vehicular display unit, and
the vehicular sound processing apparatus self-recognizes the sound stop state upon detecting an interruption of the sound data when the interruption of the sound data is within a preset period from the user operation in association with the screen image that is displayed on the vehicular display unit.

14. The vehicular apparatus of claim 11, wherein
the vehicular display unit displays a dedicated input operation screen for receiving an input operation that controls a playback or a stop of playback of the music data stored in the memory unit, in a manner of one of (i) replacing the display of the screen image of the screen of the portable terminal and (ii) superposing on the display of the screen image of the screen of the portable terminal.
